(19) United States
(12) Patent Application Publication
(10) Pub. No.: US 2016/0015178 A1
(43) Pub. Date: Jan. 21, 2016

(54) SPRAY FOR KITCHENS AND RESTROOMS

(71) Applicant: Mohammed Abdullah ALSHADY, Omaha, NE (US)

(72) Inventor: Mohammed Abdullah ALSHADY, Omaha, NE (US)

(21) Appl. No.: 14/336,675

(22) Filed: Jul. 21, 2014

(51) Int. Cl. A47B 96/18; B32B 43/00; B29C 41/36; B29C 41/42; B29C 41/00; B29C 41/08

(52) U.S. Cl. CPC A47B 96/18; B29C 41/003; B29C 41/08; B29C 41/365; B29C 41/42; B32B 43/006; B29L 2007/00

(57) ABSTRACT

A method for temporarily protecting a hard surface by selecting a surface, applying a dose of liquid solution on the selected surface, waiting for the dose of liquid solution to solidify into a sheet, and removing the sheet from the surface. At least one dose of liquid solution is stored in a solid form in a container, and the sheet of solidified material can be removed by peeling.

### GRANT OF NON-EXCLUSIVE RIGHT

This application was prepared with financial support from the Saudia Arabian Cultural Mission, and in consideration therefore the present inventor(s) has granted The Kingdom of Saudi Arabia a non-exclusive right to practice the present invention.

### FIELD OF THE DISCLOSURE

The invention generally relates to a method for temporarily protecting a hard surface by forming a solid sheet on the surface, specifically a method that includes spraying a liquid compositon onto the surface to quickly form a removable sanitary sheet. The invention further relates to a container for applying the liquid solution.

### DESCRIPTION OF THE RELATED ART

The “background” description provided herein is for the purpose of generally presenting the context of the disclosure. Work of the presently named inventors, to the extent it is described in this background section, as well as aspects of the description which may not otherwise qualify as prior art at the time of filing, are neither expressly or impliedly admitted as prior art against the present invention.

This application relates to a method of protecting surfaces. In day-to-day usage of kitchens and restrooms, people may wipe unclean surfaces with paper towels before and/or after they have finished using the surface. Wiping unclean surfaces is an obvious way of protecting the users from dirt or germs, e.g., by cleaning these surfaces.

Alternatively, surfaces may be protected or coated before use. For toilets for example, a disposable piece of plastic, attached to the toilet seat or located above the toilet seat, may be placed on a surface of the toiler and/or adjusted prior to use, and discarded after use.

However, public facilities may not always provide paper or plastic covers to protect surfaces, since these solutions may be expensive and wasteful. Furthermore, people with busy schedules may find it time consuming to wipe surfaces clean, or may decide not to do so. In another instance, counters or surfaces may become dirty, and the next person to use the surface may find it difficult to clean.

In other situations a person may wish to protect the surface coating or appearance of an item. Newly purchased articles are sometimes at least partially covered with a removed thermoplastic film. The film adheres to a surface of the article that the user desires to protect. The film provides scratch resistance and protects the surface from soiling and/or accumulation of dust and debris. Once such a protective film has been removed from a surface it is very difficult to replace it without substantially compromising the cosmetic appearance of the article. A composition or method that provides a means to newly cover a surface with a protective disposable film is desirable.

### SUMMARY

A method for temporarily protecting a hard surface by selecting a surface, applying a dose of liquid solution on the selected surface, waiting for the dose of liquid solution to solidify into a sheet, and removing the sheet from the surface after use. At least one dose of liquid solution is stored in solid form in a container, and the sheet of solidified material can be removed by peeling.

In a first exemplary embodiment, a device may be mounted to a wall or integrated with a toilet, and used to protect a toilet seat.

In a second exemplary embodiment, a device may be portable and used to protect surfaces such as kitchen counters.

In another embodiment the device and a composition contained in the device provides a means for applying a removable protective film on a surface for which cosmetic surface protection is desired.

The foregoing paragraphs have been provided by way of general introduction, and are not intended to limit the scope of the following claims. The described embodiments, together with further advantages, will be best understood by reference to the following detailed description taken in conjunction with the accompanying drawings.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings, wherein:

FIG. 1 depicts a schematic cross-sectional view of a first variant of an exemplary embodiment; and

FIG. 2 depicts a schematic cross-sectional view of a second variant of an exemplary embodiment.

### DETAILED DESCRIPTION OF THE EMBODIMENTS

It is an object and feature of an exemplary embodiment described herein to protect users from contamination and skin infections. A non-limiting exemplary embodiment protects users from germs, and reduces over-cleaning. One advantage of an exemplary embodiment described herein is the ability for households, businesses, and individuals to save time, energy and money.

The device can also be used to cover a surface to protect the cosmetic appearance of the surface and/or to protect the surface for soiling. Durable and non-durable household goods may be protected with the device and film described herein. For example, in a dusty climate an individual may wish to protect a piece of furniture from soiling or from collecting dust. Conventionally this is accomplished by covering the furniture with a thick protective plastic film (often made of polyvinyl chloride). Such plastic films may, however, severely affect the appearance and comfort of the furniture. The plastic tends to degrade upon exposure to sunlight and thereby becomes discolored or brittle. The present invention provides a way to quickly and easily spray a thin protective film on the furniture at a cost that is much lower than the costs of a conventional plastic protective film. The protective film of the invention closely matches the surface contours of the furniture and is highly flexible allowing an individual to use the furniture without consciously being aware of the presence of the protective film. The protective film also serves to exclude the accumulation of pet hairs and other common household dirt on furniture.

Another advantage of an exemplary embodiment described herein is the ability to conveniently carry and store the product, and to cover a larger surface area with a smaller amount of material. It is yet another advantage of an exemplary embodiment to be able to use the product repeatedly.

These and other objects, advantages, and features of the exemplary embodiments described herein will be apparent to one skilled in the art from a consideration of this specification, including the attached drawings.

Referring now to the drawings, like reference numerals designate identical or corresponding parts throughout the several views.

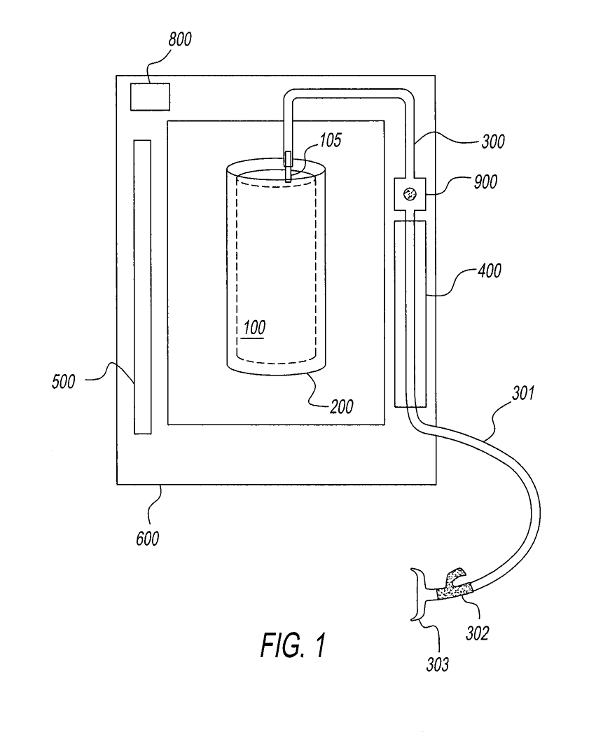

In a first non-limiting exemplary embodiment, referring to FIG. 1, the device may be fixedly mounted on a wall.

In other embodiments the device is so positioned to permit discharge or spray of a liquid onto cars to protect them when they are shipped overseas and thereby protect the cars' paint and exterior surfaces from getting damaged. The device may also be so positioned or arranged to be used by health or government inspectors when closing or restricting the operations of a store or a restaurant. For example, the liquid may be sprayed around the store or the restaurant's door edges with special color to make sure that no one enters.

In a preferred exemplary embodiment, the device may be located in a bathroom, e.g., mounted on a wall next to a toilet paper dispenser. In an alternative embodiment, the device may be integrated with the toilet seat.

In the non-limiting exemplary embodiment of FIG. 1, a cylindrical bottle 100 contains a product. In an exemplary embodiment this product may be stored as a solid when the device is off, but may be a liquid when the device is on. The device is on when it is activated by a user. The bottle 100 may be inserted into a slot 200, which encases the bottle 100. In an exemplary embodiment, the bottle 100 may be pressurized. A tubular element 105 located on the bottle 100 may be connected to a tubular element 300. When the user activating a handle 302, carries the contents of the bottle 100 to a surface where they are applied. A tubular element may include a rigid portion 300 located inside the casing 600, and a flexible portion 301. In an exemplary embodiment, flexible portion 301 of the tubular element may be partially protected from the outside environment by a cover element 400, and partially exposed to the environment, such that the user can twist the tubular element 301 and easily cover the desired surface with the contents of the bottle 100. In the exemplary embodiment shown in FIG. 1, the tubular element or hose 300 may be at least long enough to reach the toilet bowl edges.

In an exemplary embodiment, the casing 600 which holds the bottle 100 and tubular distribution system 300 may also include devices 500 located around the slot 200 encasing the bottle. In an exemplary embodiment the devices 500 may be heating elements. The heating may alternately be provided by a chemical reaction that provides heat to the contents of the device. For example, the device may be surrounded by a cavity which contains a reaction medium. Upon activation the reaction medium quickly generates heat which is transferred to the contents of the device to thereby warm and/or melt the contents of the device. In an exemplary embodiment, the casing 600 may also include an on/off switch 800, and a device 900 which can roll the tubular element 301 inside the protector element 400, such that when the device is not being used, the tubular element is coiled inside element 900, with the end piece 303 resting at the bottom of the protector element 400.

In a non-limiting example, a bathroom user is faced with a toilet seat. The user may press the on/off button 800, thereby turning on the device, with the heating elements 500 generating heat and heating the solid stored in the bottle 100 to the point that the contents of the bottle 100 become liquid. In another embodiment the device automatically adjusts the temperature and the liquid/solid state of its contents. For example, the device includes circuitry and operable instructions such that the device begins heating as soon as someone enters the bathroom. Alternately the device may include operable instructions to maintain specific temperature at which the contents are help in liquid form. Further operable instructions may include keeping the device contents liquid only at times of the day during which the toilet is most frequently used.

In an exemplary embodiment, the device may not have a thermostat but instead the at least one heating element 500 may be programmed to reach the melting point of the material inside the bottle 100 once the user activates the on/off button. The device may release enough heat to quickly melt the material inside the bottle, and allow the user to proceed by spraying a liquid. The device may include a visual signaling device whereby users are visually clued that the device is ready for dispensing. For example, the device may include an LED or other signal such as a colored light source that illuminates when the material inside the device is liquid or fully molten. The device may also include safety relay preventing discharge until the material within the device is fully molten.

The user may pull the tubular element 301 out of the protector case 400, to the desired length, and apply the end piece 303 to the toilet seat. When the user presses the release handle 302, liquid may be aspirated from the bottle 100 through tubular elements 300 and 301, and sprayed onto the desired hard surface, e.g., the toilet seat, where the contents solidify, thereby providing the user with a protective coating. The length of the tubular is preferably be between 3-4 feet and the handle is preferably 2-3 inches in size with a pressing handle that is preferably 1-1½ inch. The dimensions are so selected to permit the user to reach all the toilet bowl's edges and for to also allow the kitchen user to reach all counter surfaces. The diameter of the tubular is preferably about ½ inches or less. When the user stops pressing the release handle, liquid is no longer aspirated from the bottle 100. In an exemplary embodiment, pressurization of the bottle 100 may help with distribution of the liquid through the tubular elements. The tubular elements 300-301 preferably retract into the device subsequent to use. Retraction returns the tubular elements to an environment in which heat may be applied such that any remaining liquid present after initial discharge is in a liquid state.

In a non-limiting example, the end piece 303 may be shaped to match the width and height of a toilet seat cover. In an exemplary embodiment the end piece 303, handle 302 and tube 301 may be integral to each other. In an exemplary embodiment, the handle 302 and end piece 303 may be made of hard plastic, with the tube 301 being made of semi-rigid plastic.

In a non-limiting example, the time between the user pressing the on-off button and the ability for the user to spray the toilet seat is short, between 30 and 60 seconds. It is however not necessary for the device to be turned on/off every time a user wants to use the device. For example, the device may be turned on at all time during business hours and shut off by janitors when not needed for example during the end of a day business office at a company's office.

In a non-limiting example, dependent on the temperature difference between the melted liquid sprayed by the end piece 303, and the temperature of the surface and surroundings, the solidification process of the sprayed layer may take between 30 and 60 seconds.

In an exemplary embodiment, the device may be plugged in to derive power. The device can be powered by using the same power source as the toilet bowl sensor. Batteries may be used in place of direct electrical power. The batteries may be used as a back-up power for electricity or the batteries may be used in a device that is mobile and not permanently connected to electrical power. Such mobility may ease use of the device in areas such as kitchens

In a non-limiting exemplary embodiment, there may be a scraper element allowing the user, once done, to scrape off the coating layer from the surface, allowing the next user to spray a new layer. In a non-limiting example, the scraper element may be a separate piece affixed to the casing 600, or the end piece 303 may double as a scraper element. After peeling the material from the toilet bowl edges, the discarded layer of material may be light and thin enough to be flushed without causing any backups and flood risks. In another embodiment the liquid material contains a dye or pigment that colors the material. This permits easy identification for the user to confirm that the surface is effectively covered with the peelable membrane or material.

In a non-limiting exemplary embodiment, when the bottle 100 is empty, it can be replaced by janitors.

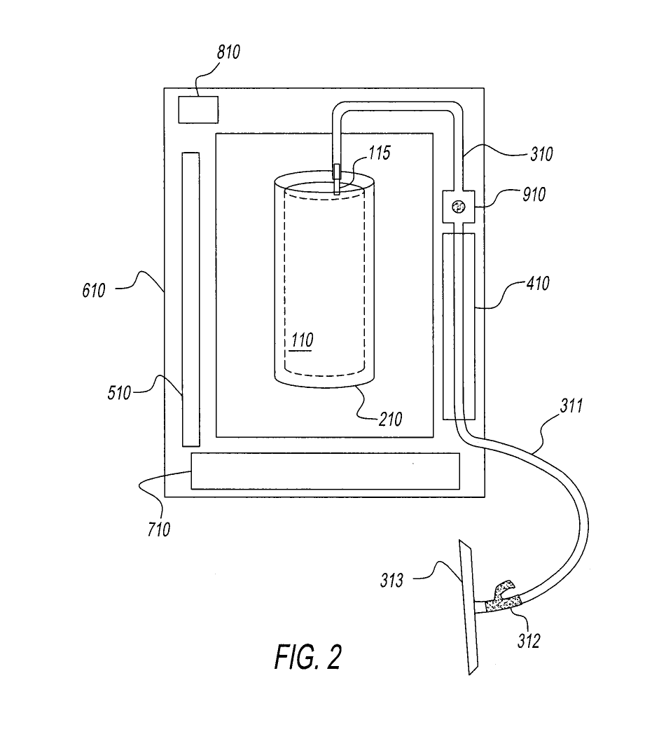

In a second non-limiting exemplary embodiment, referring to FIG. 2, the device may be small enough and light enough to be carried in a pocket or a purse. In a non-limiting exemplary embodiment, the casing 610 may have a cylindrical shape, such that the entire device is comfortable and easy to carry for the user. In this embodiment the device may be powered with one or more batteries, preferably a single AAA battery. Preferred dimensions are about 5-6 inches in length and the replaceable bottle is between 3-4 inches tall having a diameter of between 1-1½ inches. The device preferably has the shape of a paper spray. In another exemplary embodiment, the versatile device provides portable storage of a material in a solid form, and fast transformation from solid to liquid material, such that a user may spontaneously decide to spray any solid or semi-solid surface to provide protection from germs, dirt or contaminants. In the non-limiting exemplary embodiment of FIG. 2, the device may be smaller and lighter than the exemplary embodiment of FIG. 1.

In the non-limiting example of FIG. 2, the bottle 110 contains the product to be sprayed, and is inserted into a slot 210, which encases the bottle 110. In an exemplary embodiment, the bottle 110 may be pressurized. A tubular element 115 located on the bottle 110 is connected to a tubular element 310 which upon the user activating a handle 312, carries the contents of the bottle 110 to a surface where they are applied. Tubular element 310 may include a rigid portion 310 located inside the casing 610, and a flexible portion 311. In an exemplary embodiment, flexible portion 311 of the tubular element may be partially protected from the outside environment by a cover element 410, and partially exposed to the environment, such that the user can twist the tubular element 311 and easily cover the desired surface with the contents of the bottle 110.

The casing 610 which holds the bottle 110 and tubular distribution system 310 may also include heating elements 510 located around the slot 210 encasing the bottle. In an exemplary embodiment, the casing 610 may also include an on/off switch 810, and a device 510 which can roll the tubular element 311 inside the protector element 410, such that when the device is not being used, the tubular element is coiled inside element 910, with the end piece 313 resting at the bottom of the protector element 410. In an exemplary embodiment, once the user is done spraying the desired surface, .e.g. the kitchen counter, the hose 311 rolls back in the machine, coiled by element 910. In the non-limiting exemplary embodiment of FIG. 2, the casing 610 may also include an on/off switch 810, which is powered by batteries, located in a battery compartment 710.

In a non-limiting example, a user is faced with a dirty or unclean surface. In another application the device may be used to secure an area from trespass or disturbance. For example, at a crime scene the police may use the device to make sure that no evidence is removed or tampered with. This also serves to protect the police office/investigators working at the crime scene. For example, police officers can spray the crime sense with the product after they do the initial investigation to make sure no one comes at the crime senses and change the evidence. The police or investigators may spray areas or surfaces including any of the floor, bodies, prints, and surrounding areas. When they spray the surrounding area, they know if anyone try to enter the crime sense by their footprints. The user may press the on/off button 810, thereby turning on the device, with the heating elements 510 generating heat. The bottle 110 may contain a material which is stored as a solid. Upon the user turning on the device, the heating elements 510 heat up the contents of the bottle 110, such that it becomes liquid. The user may then pull the tubular element 311 out of the protector case 410, to the desired length, and apply the end piece 313 to the desired surface, such as a kitchen counter. In the non-limiting exemplary embodiment of FIG. 2, the end piece 313 may have a wide and flat opening, adapted to large flat surfaces such as kitchen counter. When the user presses the release handle 312, liquid is aspirated from the bottle 100 through tubular elements 310 and 311, and sprayed onto the desired surface, e.g. the kitchen counter, bank counter, or post-office counter, where the contents solidify, thereby providing the user with a protective coating. Other surfaces that may be targeted for protection include bank counters and post office counters.

In an exemplary embodiment the end piece 313, handle 312 and tube 311 are integral to each other. In an exemplary embodiment, the handle 312 and end piece 313 are made of hard plastic, with the tube 311 being made of semi-rigid plastic.

In an exemplary embodiment, the machine may not have a thermostat but instead the at least one heating element 510 may be programmed to reach the melting point of the material inside the bottle 110 once the user activates the on/off button. The machine may release enough heat to quickly melt the material inside the bottle, and allow the user to proceed. In a non-limiting example, the time between the user pressing the on-off button and the moment when the user is first able to spray the desired surface is short, between 30 and 60 seconds.

In a non-limiting example, dependent on the temperature difference between the melted liquid sprayed by the end piece 313, and the temperature of the surface and surroundings, the solidification process of the sprayed layer may take between 0.5 and 60 seconds. Preferably solidification is complete within 1 to 10 seconds, even more preferably within 3 to 5 seconds.

In a non-limiting exemplary embodiment, there may be a scraper element allowing the user once done to scrape off the coating layer from the surface, allowing the next user to spray a new layer. In a non-limiting example, the scraper element may be a separate piece affixed to the casing 610, or the end piece 313 may double as a scraper element. After peeling the material from the used surface, the discarded layer of material may not be bio hazardous or toxic, such that it can safely be discarded in a standard trashcan or waste container. The scraper element may be placed within the U shaped 303 in the figure. Preferably the scraper is not a separate piece from the device.

In a non-limiting exemplary embodiment, when the bottle or cartridge 110 is empty, a user can replace it to continue using the device.

In a non-limiting exemplary embodiment, as shown in FIG. 1 or 2, a material may be stored as a solid within a bottle 100, 110, and sprayed as a liquid, after being heated to a liquid state by resistance heating elements 500, 510.

In an exemplary embodiment, the sprayed solution solidifies quickly, adheres to the surface, and can easily be removed. In an exemplary embodiment, the sprayed liquid solution may be a premixed solution comprising a liquid medium and solid particles.

In an exemplary embodiment, the material used may be selected from plastic or rubber materials. In an exemplary embodiment, the material used may be a synthetic wax, such as a polymer wax with a narrow melting point. Wax materials may not require high temperatures to transition from solid to liquid states, and require only a few seconds to transition from liquid to solid state. In an exemplary embodiment, the material used may be selected from non-hazardous materials within the cyanoacrylate family of adhesives, which provide a quick curing time. In an exemplary embodiment, a material used may be one that dissolves in contact with water, i.e. hydrophilic. In an exemplary embodiment, the material to be sprayed may be a low melting synthetic polymer which is safe for human contact, and safe to dispose in the trash.

In alternate exemplary embodiment, the material sprayed may be a mixture of a volatile compound containing rubber or plastic materials, such that when the material is sprayed the mixture dissipates, leaving a coating of rubber or plastic materials. In an alternate exemplary embodiment, elements 500 and 510 may be elements other than heating elements or may not be required. For example, 500 is preferably the heating element that may alternately be a thin piece of metal that gives enough heat to melt the material inside the bottle. 510 is preferably not a heating element but instead functions to roll the tubular portion back inside the machine to keep the materials inside the hose in liquid form.

In an alternate embodiment an agent may be mixed in the solution stored in bottle 100 to accelerate solidification of the product on the desired surface.

In an exemplary embodiment, a material for the casing 600, 610 may be a stainless steel or hard plastic to provide protection for the interior elements, and to keep the heat inside. In an exemplary embodiment, a material for the bottle 100 may be safe when exposed to heat such that there is no risk of explosion when the contents of the bottle are heated.

Thus, the foregoing discussion discloses and describes merely exemplary embodiments of the present invention. As will be understood by those skilled in the art, the present invention may be embodied in other specific forms without departing from the spirit or essential characteristics thereof. Accordingly, the disclosure of the present invention is intended to be illustrative, but not limiting of the scope of the invention, as well as other claims. The disclosure, including any readily discernible variants of the teachings herein, define, in part, the scope of the foregoing claim terminology such that no inventive subject matter is dedicated to the public.

1: A method for temporarily protecting a hard surface, comprising at least one iteration of the following steps:
selecting a surface;
applying a dose of liquid material on the selected surface from a pressurized container to form a thin continuous film over the surface to be protected;
waiting for the dose of the liquid material to solidify and form a solid sheet; and
removing the solid sheet from the surface,
wherein at least one dose of the liquid material is stored in the pressurized container, and
wherein the sheet is removed by peeling.

2: The method as claimed in claim 1, wherein the liquid material is a premixed composition comprising a medium and solid particles.

3: The method as claimed in claim 2, the liquid material further comprises an agent for accelerating the solidification.

4: The method as claimed in claim 1, wherein the solid sheet is a hydrophilic surface.

5: The method as claimed in claim 1, wherein the solid sheet adheres to the selected surface.

6: The method as claimed in claim 1, wherein applying the liquid material includes spraying the liquid material from the pressurized container.

7: The method as claimed in claim 1, wherein the at least one dose of liquid material stored in the container is stored as a solid.

8: The method as claimed in claim 7, further comprising a step of transforming the stored solid into the liquid material before applying the dose of the liquid material on the selected surface.

9: The method as claimed in claim 1, wherein the container is portable.

10: An apparatus for protecting a surface, comprising:
a casing with an on/off switch and power source;
a bottle containing at least one dose of solution;
a bottle holder located within the casing, which holds the bottle;
a hose with a first end connected to the bottle, and a second end located outside of the casing, the second end fitted with a dispenser; and
a handle located on the hose near the second end of the hose,
wherein a user turns on the apparatus, and activates the handle to release the at least one dose of solution on a surface, and
wherein the at least one dose of solution solidifies on the surface and forms a protective sheet.

11: The apparatus as claimed in claim 10, the casing further comprising heating elements to heat the stored solid into a liquid solution before the dose of liquid solution on the selected surface.

12: The apparatus as claimed in claim 10, the apparatus further comprising a scraper element to remove the protective sheet from the surface.

13: The apparatus as claimed in claim 10, wherein the power source uses batteries.
